(19) United States
(12) Patent Application Publication
(10) Pub. No.: US 2022/0067634 A1
(43) Pub. Date: Mar. 3, 2022

(54) DELIVERY METHOD AND SYSTEM USING ROBOT

(71) Applicant: NAVER LABS CORPORATION, Seongnam-si (KR)

(72) Inventors: Seijin CHA, Seongnam-si (KR); Hyeoncheol LEE, Seongnam-si (KR); Seoktae KIM, Seongnam-si (KR)

(73) Assignee: NAVER LABS CORPORATION, Seongnam-si (KR)

(21) Appl. No.: 17/388,617

(22) Filed: Jul. 29, 2021

(30) Foreign Application Priority Data
Aug. 31, 2020 (KR) 10-2020-0110559

(51) Int. Cl. G06Q 10/08; B25J 9/16; B25J 11/00; G06F 16/9035; G06F 16/9038

(52) U.S. Cl. CPC G06Q 10/083; B25J 9/1661; G06F 16/9038; G06F 16/9035; B25J 11/008

(57) ABSTRACT

According to at least some example embodiments, a delivery method includes acquiring invoice information of an object based on scanning of the object by a scanner; specifying a target user matched with the invoice information by using a user database (DB); extracting target information corresponding to the target user from the user DB; generating identification information based on the invoice information and the target information; generating an identification mark, including the identification information, to be attached to the object; and controlling a robot which has scanned the identification mark to deliver the object to the target user.

### CROSS-REFERENCE TO RELATED APPLICATION

Pursuant to 35 U.S.C. § 119(a), this application claims the benefit of the earlier filing date and the right of priority to Korean Patent Application No. 10-2020-0110559, filed on Aug. 31, 2020, the contents of which is incorporated by reference herein in its entirety.

### BACKGROUND

### 1. Field

At least some example embodiments relate to a delivery method and system using a robot capable of efficiently performing delivery of an object by using a robot.

### 2. Related Art

As technology advances, various service devices emerge, especially in recent years, technology development for robots that perform various tasks or services is actively ongoing.

Furthermore, recently, as artificial intelligence technologies and cloud technologies have evolved, the utilization of robots is gradually increased.

Recently, robots replace a human's task or operation. Especially, methods for directly providing services to humans are being actively researched.

Meanwhile, recently, services to directly deliver objects such as postal matters and logistics to a user by using a robot are being introduced gradually.

For instance, Korean Laid-Open Patent No. 10-2018-0123298 (A delivery robot device, an operation method thereof and a service server) discloses a system which delivers objects collected in a delivery area by a postman, to an original delivery destination, by using a delivery robot device. Like this, development and research of techniques for automation of object delivery using a robot are actively ongoing.

### SUMMARY

Therefore, at least some example embodiments may provide a delivery method and system using a robot, capable of performing delivery of an object by using a robot.

More specifically, at least some example embodiments may provide a delivery method and system using a robot, capable of collecting objects delivered from a postman systematically and efficiently.

Also, at least some example embodiments may provide a delivery method and system using a robot, capable of directly delivering collected objects to a user, through an automated delivery system using a robot.

According to at least some example embodiments, a delivery method includes acquiring invoice information of an object based on scanning of the object by a scanner; specifying a target user matched with the invoice information by using a user database (DB); extracting target information corresponding to the target user from the user DB; generating identification information based on the invoice information and the target information; generating an identification mark, including the identification information, to be attached to the object; and controlling a robot which has scanned the identification mark to deliver the object to the target user.

The extracting of the target information may include extracting target information including location information of the target user from the user DB, the location information identifying a location the robot can access.

The identification information may include code information which can be identified by a robot scanner, the robot scanner being a scanner included in the robot, and the code information may include at least one of the invoice information, name information of the target user, and the location information.

The method may further include updating the user DB such that at least one of the invoice information and information on a storage place where the object is stored is included in the target information.

The method may further include transmitting notification information indicating existence of a delivery event with respect to the object to an electronic device of the target user registered to the user DB, based on the updating of the user DB.

The method may further include receiving delivery request information including a reservation time related to the delivery event from the electronic device of the target user, and the controlling of the robot may include controlling the robot to deliver the object to the target user at the reservation time.

The method may further include in response to the identification mark attached to the object being scanned by a robot scanner, generating a delivery start event related to the object for the target user, the robot scanner being a scanner included in the robot, and updating information on the delivery start event to the user DB.

The method may further include transmitting, to the electronic device of the target user, notification information indicating that delivery of the object has started, based on the updating of the information on the delivery start event to the user DB.

The method may further include extracting information on a storage place where the object has been stored, and outputting the information on the storage place to a display, based on reception of the delivery request information.

The information on the storage place may be output to the display, at a time that precedes the reservation time by a first amount of time.

According to at least some example embodiments, a delivery system includes memory configured to store a user database (DB); a scanner configured to scan an object; and controller circuitry configured to acquire invoice information of the object based on scanning of the object by the scanner, and extract target information corresponding to a target user matched with the invoice information, wherein the controller circuitry is further configured to, generate identification information based on the invoice information and the target information, and generate an identification mark including the identification information, to be attached to the object, and wherein the controller circuitry is further configured to control a robot which has scanned the identification mark to deliver the object.

As is mentioned above, in the delivery method and system using a robot, information on a target user corresponding to a recipient of an item (or an object) to be delivered may be acquired based on invoice information attached to the object. Further, according to at least some example embodiments, an identification mark which can be scanned by a robot may be generated by using the acquired target user information and the invoice information, and the object may be delivered to the target user by a robot which has scanned the identification mark. Accordingly, in the delivery method and system using a robot, a manager who manages object delivery allows the robot to deliver the object to the target user, even if he or she does not directly input information on a destination of the object. This may enhance efficiency of a task.

Further, in the delivery method and system using a robot, information on a storage place where collected objects have been stored is input to the user DB. Accordingly, in a case that the target user requests for object delivery, the information on the storage place may be provided from the user DB. This may reduce difficulty of the manager (or operator) who manages object delivery in directly searching for the storage place where the object has been stored, in order to deliver the object to the target user.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments of the inventive concepts and should not be interpreted to limit the intended scope of the claims. The accompanying drawings are not to be considered as drawn to scale unless explicitly noted.

FIGS. 1 to 3 are conceptual views for explaining a delivery method and system using a robot according to at least some example embodiments;

FIG. 4 is a conceptual view for explaining a robot recognition method in a delivery method and system using a robot according to at least some example embodiments;

FIG. 5 is a conceptual view for explaining a method to estimate a location of a robot in a delivery method and system using a robot according to at least some example embodiments;

FIG. 6 is a flowchart for explaining an object delivery method using a robot according to at least some example embodiments; and

FIGS. 7, 8, 9A, 9B, 10A, 10B, 10C, 10D, FIG. 11, FIG. 12A and FIG. 12B are conceptual views for explaining an object delivery method using a robot according to at least some example embodiments.

### DETAILED DESCRIPTION OF THE EMBODIMENTS

Example embodiments disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices may include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

Alternatively, or in addition to the processors discussed above, the hardware devices may include one or more Central Processing Units (CPUs), digital signal processors (DSPs), application-specific-integrated-circuits (ASICs), SoCs, field programmable gate arrays (FPGAs), or the like. In at least some cases, the one or more CPUs, SoCs, DSPs, ASICs and FPGAs, may generally be referred to as processing circuits and/or microprocessors.

The hardware devices may also include one or more storage devices. The one or more storage devices may be tangible or non-transitory computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments described herein. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

It will be apparent to those skilled in the art that various modifications and variations can be made to the example embodiments without departing from the spirit or scope of the inventive concepts described herein. Thus, it is intended that the example embodiments cover the modifications and variations of the example embodiments provided they come within the scope of the appended claims and their equivalents.

Description will now be given in detail according to example embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present specification, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, example embodiments should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of features, numbers, steps, functions, several components, or combinations thereof, disclosed in the specification, and it is also understood that greater or fewer features, numbers, steps, functions, several components, or combinations thereof may likewise be utilized.

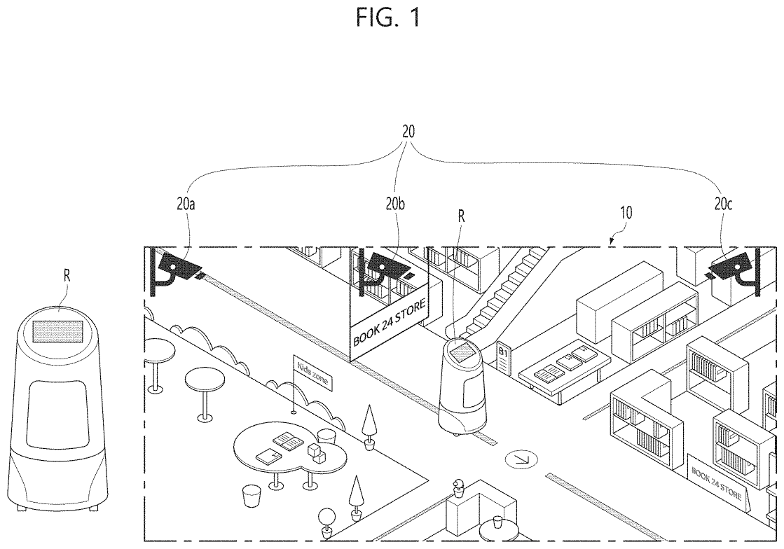

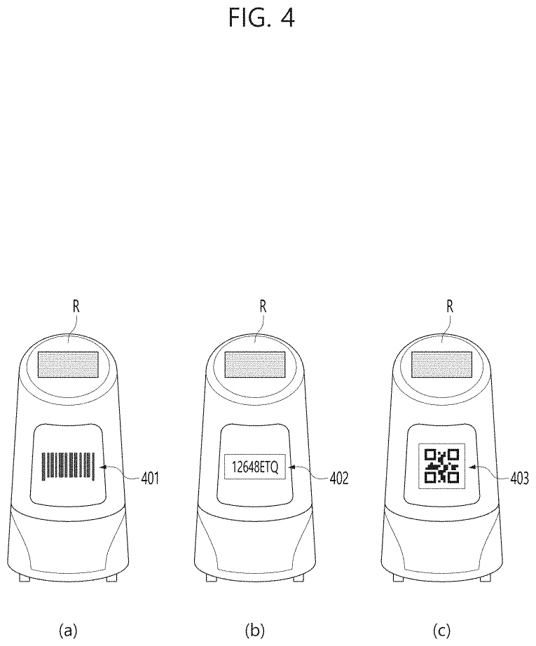

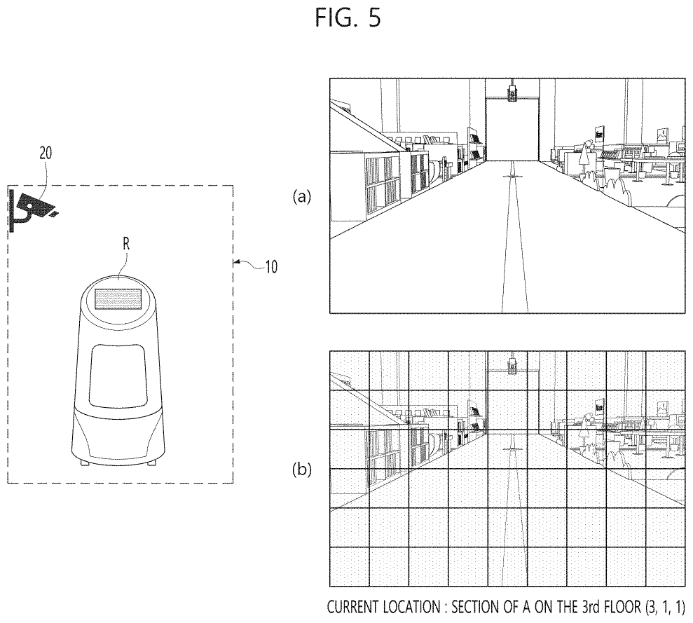

At least some example embodiments relate to a delivery method and system using a robot, and more particularly, to a method capable of efficiently performing delivery of an object. Hereinafter, a space where a robot drives and a robot control system surrounding the space will be described with reference to the accompanying drawings. FIGS. 1 to 3 are conceptual views for explaining a delivery method and system using a robot according to at least some example embodiments. FIG. 4 is a conceptual view for explaining a robot recognition method in a delivery method and system using a robot according to at least some example embodiments. And FIG. 5 is a conceptual view for explaining a method to estimate a location of a robot in a delivery method and system using a robot according to at least some example embodiments.

As technology advances, the utilization of robots is gradually increasing. Robots have traditionally been used in special industries (e.g., industrial automation related fields), but are increasingly transformed into service robots that can perform useful tasks for humans or facilities.

A robot capable of providing such diverse services may be configured to drive in the space 10, as shown in FIG. 1, to perform assigned tasks. There is no limit to the type of space in which the robot (R) drives, and it can be made to drive at least one of the indoor and outdoor spaces as needed. For example, indoor spaces may be a variety of spaces, such as department stores, airports, hotels, schools, buildings, subway stations, train stations and bookstores. Thus, the robot (R) may be arranged in various spaces to provide useful services to human beings. Meanwhile, the robot in accordance with at least some example embodiments may be referred to variously, for instance, an unmanned moving machine, an autonomous moving machine, etc.

As shown in FIG. 1, a camera 20 may be placed in the space 10 where the robot is located. As shown, the number of the cameras placed in the space 10 is unlimited. Multiple cameras 20a, 20b, 20c may be placed in the space 10, as shown. The types of the cameras 20 placed in the space 10 may vary, and a closed circuit television (CCTV) placed in the space 10 may be utilized in particular.

The robot (R) which drives the space 10 may include a service robot for providing a service to a user. The service provided to a user by the robot (R) may be various. For instance, the robot (R) may deliver objects (e.g., postal matters, logistics, etc.), or may serve beverages. The robot (R) which provides such services may be configured to directly meet a user to which a service is to be performed (hereinafter, will be referred to as a “target user”) in the space 10, and to provide a service to the target user.

Meanwhile, the operation to provide a service by the robot (R) may be understood as performance of a task by the robot (R). For example, the robot (R) is configured to provide a service to the target user by performing an allocated task. Hereinafter, for convenience of explanations, “providing a service by the robot (R)” will be expressed as “performing a task by the robot (R)”.

At least some example embodiments may provide a method and system for providing a thing (item) delivery service by using a robot, among services provided from the robot (R). Everyday, a large number of stuffs corresponding to dozens of, hundreds of, and thousands of things (items) may undergo accumulation in spaces where many people live together such as company buildings, hospitals, schools and apartments.

Here, the accumulation means that things (items) are collected for delivery. In a specific space corresponding to the aforementioned various places (company buildings, hospitals, schools and apartments, etc.), an item delivery system may be operated by primarily collecting items delivered to each individual who lives in the specific space, and then delivering the items to each individual by using the robot (R) which drives the specific space.

Thus, the delivery method and system using the robot (R) according to at least some example embodiments proposes a method capable of comprehensively performing i) a process of collecting items from a postman, ii) a process of specifying a specific user who is to receive the collected items, and iii) a process of delivering the items to the specific user by using the robot (R).

According to at least some example embodiments, the things (items) may be, for example, objects received from a postman and to be delivered, and may be logistics, postal matters, etc. For example, there is no limitation in the type of the things. Hereinafter, for unification of the terms, the collected “things” and/or “items” will be referred to as “objects”.

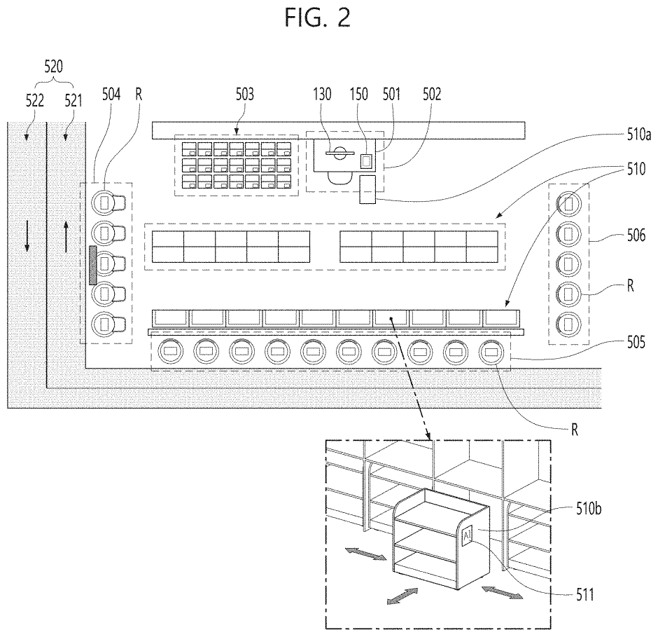

Referring to FIG. 2, in the delivery method and system using the robot (R) according to at least some example embodiments, objects 503 are collected at a specific place (e.g., a delivery working place) in the space 10. Here, as is mentioned above, the objects mean items delivered by a postman, and the postman may deliver the objects 503 to a specific place.

Further, according to at least some example embodiments, a robot navigation region 520 may be an area where the robot (R) drives. The robot navigation region 520 may be formed as a space for exclusive use by the robot. The robot (R) may be configured to drive on the robot navigation region 520 for an efficient delivery task. In this case, the robot (R) may be programmed to drive within the robot navigation region 520.

The robot navigation region 520 may include a first region 521 and a second region 522 on different navigation direction regions. The robot (R) may drive on only one of the first region 521 and the second region 522 according to a navigation direction.

According to at least some example embodiments, there may be a plurality of robot operation regions 504, 505, 506. The plurality of robot operation regions 504, 505, 506 are regions for operating the robot with different purposes. The first robot operation region 504 may be a waiting region of at least one robot which is to receive a task in order to deliver the object.

The second robot operation region 505 among the plurality of robot operation regions 504, 505, 506 may be a power charging region, where the robot requiring power charging may be located. In the case that the robot is located at the second robot operation region 505, the robot (R) may perform power charging by using at least one of a wired method and a wireless method.

The third robot operation region 506 among the plurality of robot operation regions 504, 505, 506 may be a waiting region of the robot (R) which has not completed task performance. Here, the incompletion of task performance may mean a state of the robot (R) which has started to drive in order to deliver the object to a target user, but has not completed the delivery of the object to the target user due to a situation of the target user or other situation. For example, the third robot operation region 506 may be a waiting region of the robot (R) for return of the object stored in the robot (R).

Meanwhile, in the system according to at least some example embodiments, the robot to be operated may be located on one of the plurality of robot operation regions 504, 505, 506 according to a purpose.

Further, according to at least some example embodiments, a location in which the system according to at least some example embodiments may be operated may include a reception region 502 to receive the collected object 503.

As shown, the reception region 502 may include at least one of a display unit 130 and a scan unit 150. The scan unit 150 may be configured to acquire invoice information included in the object 503.

In this specification, for convenience of explanations, “invoice information” is used for unification of terms. However, the “invoice information” can be replaced by another term.

For instance, the “invoice information” may be expressed as “information about an object”.

The invoice information includes information on a target user (recipient) to which the object is to be delivered, and may further include at least one of postal matter information, an invoice number, delivery company information, sender information, and description information about the object (e.g., a type of the object (shoes, clothes, etc.).

According to at least some example embodiments, in case of collecting the objects 503, the collected objects may be received at the reception region 502. The reception of the objects may include a task to acquire invoice information included in the objects, and to specify a target user of the objects.

Further, a location in which the system according to at least some example embodiments may be operated may include a storage place (or a storage region 510) to store the object 503 having been received at the reception region 502. As shown, the storage place 510 may include a plurality of storage boxes 510b. The received object may be stored in the storage box 510b until it is delivered to the target user by the robot (R). Meanwhile, at the reception region 502, the received object may be stored in a specific storage box 510a. According to at least some example embodiments, each of the storage boxes may be provided with different identification information 511. In the system according to at least some example embodiments, in response to receiving the object at the reception region 502, i) invoice information of the object, ii) target information on a target user corresponding to a recipient of the object, and iii) identification information 511 of the storage box where the object is stored may be stored in a matching manner. Thus, the system according to at least some example embodiments may provide a systematic process to collect the object at a specific place and then to deliver the object to the target user, by using the above matching information.

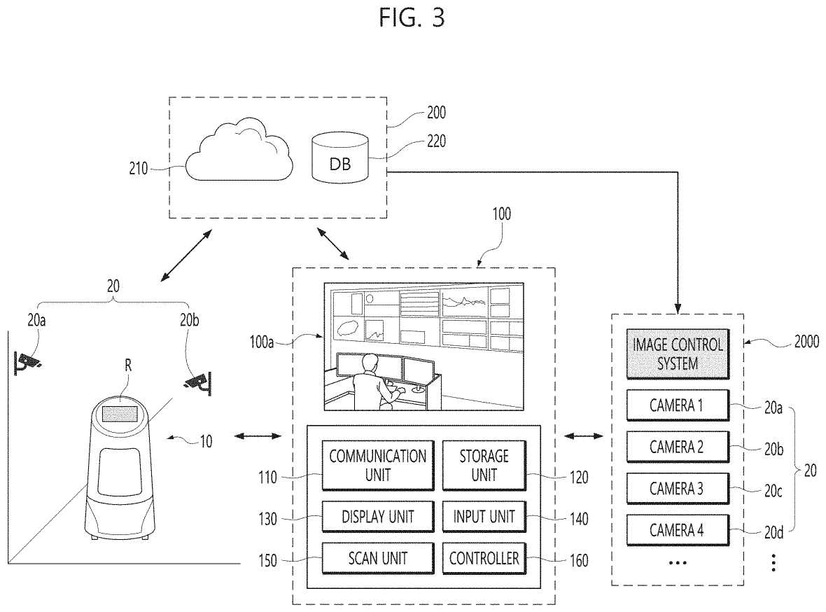

As shown in FIG. 3, a delivery system 100 in accordance with at least some example embodiments may include at least one of a communication unit 110, a storage unit 120, a display unit 130, an input unit 140, a scan unit 150 and a controller 160.

The communication unit 110 may be configured to communicate with a variety of devices placed in the space 10, in a wireless or wired manner. The communication unit 110 may communicate with at least one of the robot (R), an external server 200 and an image control system 2000 as shown in the drawings. According to at least some example embodiments, one or both of the external server 200 and the image control system 2000 may include processing circuitry such as hardware including logic circuits; a hardware/software combination executing software; or a combination thereof. For example, the processing circuitry more specifically may include, but is not limited to, one or more of a central processing unit (CPU), a processor core, an arithmetic logic unit (ALU), a digital signal processor, a microcomputer, a field programmable gate array (FPGA), a programmable logic unit, a microprocessor, an application-specific integrated circuit (ASIC), etc. The processing circuitry of the external server 200 and/or image control system 2000 may be configured, via hardware and/or software (e.g., firmware), to perform and/or control any operation described in the specification as being performed by an external storage unit, an external server, an image control system, an external camera, or an element thereof.

For instance, the communication unit 110 may receive data (e.g., images captured from the robot (R), sensing data, etc.) from the robot (R), or may transmit a control command to the robot (R).

Furthermore, the communication unit 110 may perform direct communication with the camera 20 placed in the space 10. Furthermore, the communication unit 110 may be configured to communicate with the image control system 2000 that controls the camera 20. In a case that the communication unit 110 communicates with the image control system 2000, the delivery system 100 may receive an image captured (or received) by (from) the camera 20, from the image control system 2000, through the communication unit 110.

Furthermore, the communication unit 110 may be configured to communicate with at least one external server (or external storage unit 200). Here, the external server 200 may be configured to include at least one of a cloud server 210 and a database 220, as shown. Meanwhile, the external server 200 may be configured to perform at least a part of the controller 160. According to at least some example embodiments, operations such as data processing or data computation can be performed, for example, on the external server 200.

Further, the communication unit 110 may be configured to communicate with an electronic device of a user (or a target user). Here, a type of the electronic device is limitless, and may be a smartphone, a tablet PC, etc.

Meanwhile, the communication unit 110 may support a variety of communication methods according to a communication specification of a device with which it communicates.

For instance, the communication unit 110 may be configured to communicate with a device (including a cloud server) located in and out of the space 10, using at least one of WLAN(Wireless LAN), Wi-Fi(Wireless-Fidelity) Direct, DLNA(Digital Living Network Alliance), WiBro(Wireless Broadband), WiMAX(World Interoperability for Microwave Access), HSUPA(High Speed Uplink Packet Access), LTE(Long Term Evolution-Advanced), 5G(5^{th} Generation Mobile Telecommunication), Bluetooth™, RFID(Radio Frequency Identification), Infrared Data Association; IrDA, UWB(Ultra-Wideband), ZigBee, NFC(Near Field Communication), and Wireless USB(Wireless Universal Serial Bus). According to at least some example embodiments, the communication unit 310 may be implemented by circuits or circuitry. Accordingly, the communication unit 310 may also be referred to in the present specification as communication circuitry 310.

Next, according to at least some example embodiments, the storage unit 120 may be configured to store various information. According to at least some example embodiments, the storage unit 120 may be equipped with the delivery system 100 itself. In contrast, at least a part of the storage unit 120 may mean at least one of the cloud server 210 and the database 220. According to at least some example embodiments, it can be understood that the storage unit 120 is sufficient if necessary information for robot control is stored, and there is no constraint on physical space. Thus, the storage unit 120, the cloud server 210 and the database 220 are not separately identified, but all are described as the storage unit 120. Here, the cloud server 210 may mean “cloud storage”.

First, information on the robot (R) may be stored in the storage unit 120.

Information about the robot (R) may vary widely and may include, for example, i) identification information (for instance, serial numbers, TAG information, QR code information, etc.) for identifying the robot (R) placed in the space 10, ii) task information assigned to the robot (R) (e.g., a task type, an operation according to a task, information on a target user to which a task is to be performed, a task performance place, a scheduled time for task performance, etc.), iii) navigation path information set to the robot (R), iv) location information of the robot (R), v) status information of the robot (R) (for example, a power condition, presence of a malfunction, a battery condition, etc.), vi) image information received from a camera equipped in the robot (R), vii) operation information related to an operation of the robot (R), etc.

Next, information on the camera 20 may be stored in the storage unit 120.

The information on the camera 20 may be variable, and may include i) identification information of each camera (20a, 20b, 20c, 20d . . . ) (e.g., serial numbers, TAG information, QR code information, etc.), ii) arrangement position information of each camera (20a, 20b, 20c, 20d . . . ) (e.g., information on a specific position in the space where each camera (20a, 20b, 20c, 20d . . . ) is arranged), iii) information on an angle of view of each camera (20a, 20b, 20c, 20d . . . ) (e.g., information on a specific view in the space captured by each camera (20a, 20b, 20c, 20d . . . )), iv) position information on a region (or a space or a specific space) corresponding to an angle of view of each camera (20a, 20b, 20c, 20d . . . ), v) status information of each camera (20a, 20b, 20c, 20d . . . ) (e.g., a power condition, presence of a malfunction, a battery condition, etc.), vi) image information received from each camera (20a, 20b, 20c, 20d . . . ), etc.

The information on the camera 20 may exist in a matching manner on the basis of each camera (20a, 20b, 20c, 20d . . . ).

For instance, at least one of identification information of the specific camera 20a, position information, view angle information, status information and image information may exist in the storage unit 120 as matching information. Such matching information may be effectively utilized to later specify a space (or a place or a region) where a specific camera is located, or to identify a position of a user (e.g., a target user) positioned in a corresponding space.

Further, the storage unit 120 may store information related to a plurality of users user. Such user-related information may be referred to as a “user database (DB)” in the present specification.

The user-related information may be also referred to as “user's identification information”.

The user-related information may include at least one of a user name, a date of one's birth, an address, a phone number, an employee identification number, an ID, a facial image, bio information (fingerprint information, iris information, etc.), a user's living place in the space 10 (e. g, a working place (or a working region), a residential place, etc.), identification information of an electronic device of a user, and information related to a user's plan (schedule).

Further, the storage unit 120 may store invoice information of the received object (or information about the object). As is mentioned above, the invoice information may include information on a target user (recipient) to which the object is to be delivered. Besides the information on a target user (recipient), the invoice information may further include at least one of postal matter information, an invoice number, delivery company information, sender information, and description information about the object (e.g., a type of the object (shoes, clothes, etc.).

In the user DB of the storage unit 120, i) invoice information of the object, ii) target information on a target user corresponding to a recipient of the object, and iii) identification information 511 of the storage box where the object is stored may exist in a matching manner.

For example, in a case that the object for the target user is received, the user DB may be updated such that invoice information of the received object, stored in the user DB, is included in the target information about the target user.

Further, the storage unit 120 may further include storage box information.

The storage box information may include at least one of identification information included in each of the storage boxes (e.g., refer to identification number 511 of FIG. 2) and information about the object stored in each storage box (e.g., at least a part of invoice information).

For example, based on the storage box information, it may be certified that a specific object is stored in a specific storage box among the plurality of storage boxes.

Such storage box information may be included in the user DB as aforementioned. For example, the target information about the target user stored in the user DB may further include invoice information of the object delivered to the target user, and identification information (or storage box information) of a storage box where the corresponding object has been stored.

Meanwhile, the storage unit 120 may further include identification information of the robot (R) which performs delivery of the object.

In this case, at least one of i) information about the object (e.g., invoice information), ii) identification information of a specific robot allocated with a delivery task with respect to the corresponding object, iii) target information of the target user, and iv) identification information of a storage box where the corresponding object has been stored may be stored in the storage unit 120 in a matching manner. Further, the matching information may be included in the user DB. The matching information may exist on the basis of the target information of the user DB. For example, the target information of the target user may further include i) information about the object (e.g., invoice information), ii) identification information of a specific robot allocated with a delivery task with respect to the corresponding object, and iii) identification information of a storage box where the corresponding object has been stored.

Further, the storage unit 120 may store therein serial numbers about the object, and the serial numbers may be generated by the delivery system 100 according to at least some example embodiments. The serial numbers about the object may be additionally stored in the aforementioned user DB. The serial numbers may be referred to as identification information or serial information, and may include information represented as at least one of numbers, letters and diagrams.

Next, in the storage unit 120, a map (or map information) for the space 10 may be stored. Here, the map may be configured as at least one of two or three dimensional map. The map for the space 10 may mean a map that can be utilized to certify a current location of the robot (R) or a user, to establish a navigation path of the robot (R), or to make the robot (R) drive.

In particular, in the delivery system 100 in accordance with at least some example embodiments, it is possible to certify a location of the robot (R) based on an image received from the robot (R). To this end, the map for the space 10 stored in the storage unit 120 may consist of data that allows location estimation based on an image.

Here, the map for the space 10 may be a map preset based on Simultaneous Localization and Mapping (SLAM) by at least one robot moving in the space 10.

Meanwhile, in addition to the types of information listed above, various information may be stored in the storage unit 120.

Next, the display unit 130 is equipped in a device of a user or a manager who manages the robot (R) remotely, and may be installed in a control room 100a, as shown in FIG. 3. Alternatively, the display unit 130 may be or include a display (e.g., a touchscreen) equipped in a mobile device. As such, according to at least some example embodiments, the display unit 330 may be or include any known type of display device.

As shown in FIG. 2, the display unit 130 may be arranged at a reception place to receive the collected objects 503. At least one display unit 130 may be arranged at the reception region 502.

Next, the input unit 140 is for inputting information from the user (or the manager), which may be a medium between the user (or the manager) and the delivery system 100. More specifically, the input unit 140 may mean an input means of receiving a control command for remotely controlling the robot (R), from the user. Here, the user may be different from a target user who is a subject to which a service is to be performed.

Here, there are no specific restrictions on the type of the input unit 140, and the input unit 140 may include at least one of mechanical input means (or mechanical keys, e.g., a mouse, a joystick, physical buttons, a dome switch, a jog wheel, a jog switch, etc.) and touch-type input means. For example, the touch-type input means may be a virtual key, a soft key, or a visual key that is displayed on a touch screen through software processing, or may be a touch key that is placed outside of the touch screen. Meanwhile, the virtual key or the visual key can be displayed on the touch screen in various forms, for example, graphics, texts, icons, videos, or a combination thereof. Here, when the input unit 140 includes a touch screen, the display unit 130 may be configured as the touch screen. In this instance, the display unit 130 may perform both roles of information output and information reception.

The scan unit 150 is configured to scan at least one of the object, the storage box and the robot, and may have a different scanning method according to a form of information to be scanned.

More specifically, the scan unit 150 may perform a scanning operation with respect to at least one of an invoice attached to the object (or information on a sender or a recipient written on the object, etc.), an identification mark included in the robot, and an identification mark included in the storage box.

The scan unit 150 may be scanner, for example, an optical scanner configured to scan information corresponding to letters, marks, patterns, etc. formed as one of one dimension, two-dimension, and three-dimension. Such information may include a QR code or a barcode. For example, the scan unit 150 may be or include a barcode scanner, a QR code scanner, and/or an optical character recognition (OCR) scanner.

Further, according to at least some example embodiments, the scan unit 150 may be scanner that includes a reader (e.g., an RFID reader and/or NFC reader) configured to scan an RFID tag and/or an NFC tag.

Next, the controller 160 may be configured to control the overall operations of the delivery system 100 according to at least some example embodiments. The controller 160 may process signals, data, information, etc. that are input or output through the components shown above, or provide or process appropriate information or functions to the user. The controller 160 may be or include processing circuitry such as hardware including logic circuits; a hardware/software combination executing software; or a combination thereof. For example, the processing circuitry more specifically may include, but is not limited to, one or more of a central processing unit (CPU), a processor core, an arithmetic logic unit (ALU), a digital signal processor, a microcomputer, a field programmable gate array (FPGA), a programmable logic unit, a microprocessor, an application-specific integrated circuit (ASIC), etc. The processing circuitry of the controller 160 may be configured, via hardware and/or software (e.g., firmware), to perform and/or control any operation described in the specification as being performed by a controller, a robot control system (e.g., the delivery system 100), or an element thereof. The controller 160 may also be referred to in the present specification as controller circuitry 160.

The controller 160 may be configured to allocate a task to the robot (R). For task allocation to the robot (R), the controller 160 may transmit a control command related to a task to the robot (R), by using the communication unit 110. Such a control command may include a control to perform a task by the robot (R).

The controller 160 may perform control related to navigation of the robot (R), such that the robot (R) moves to a specific place matched with a task. The controller 160 may transmit a control command corresponding to a task to the robot (R), thereby controlling the robot (R) to move to a specific place matched with the task.

Here, the control command corresponding to a task allocated to the robot (R) may include task information. As is mentioned above, the task information may include information related to at least one of a task type, an operation according to a task, information on a target user to which a task is to be performed, a task performance place (or a specific place matched with a task) and a scheduled time for task performance.

According to at least some example embodiments, the task allocated to the robot (R) may correspond to a delivery service to deliver the object to the target user.

Further, for delivery of the objects to the target user, the controller 160 may be configured to control i) a process of collecting the objects from a postman, ii) a process of specifying a specific user who is to receive the collected objects, and iii) a process of delivering the objects to the specific user by using the robot (R).

According to at least some example embodiments, when a control command corresponding to a task is received from the controller 160, the robot (R) may move to a place matched with the task in order to execute the allocated task. For example, the robot (R) may include a controller. The controller of the robot (R) may also be referred to, in the present specification, as the robot controller. The robot controller may be or include processing circuitry such as hardware including logic circuits; a hardware/software combination executing software; or a combination thereof. For example, the processing circuitry more specifically may include, but is not limited to, one or more of a central processing unit (CPU), a processor core, an arithmetic logic unit (ALU), a digital signal processor, a microcomputer, a field programmable gate array (FPGA), a programmable logic unit, a microprocessor, an application-specific integrated circuit (ASIC), etc. The processing circuitry of the robot controller may be configured, via hardware and/or software (e.g., firmware), to perform and/or control any operation described in the specification as being performed by a controller, a robot control system (e.g., the delivery system 100), or an element thereof. The robot controller may also be referred to in the present specification as robot controller circuitry. The controller of the robot (R) may move to the task execution place based on task related information received from the delivery system 100.

As shown in FIG. 3, the robot (R) may be provided with an accommodation box (Ra) to accommodate the objects therein. The accommodation box (Ra) may be formed to have a three-dimensional space. The robot (R) may provide a service to deliver the objects accommodated in the accommodation box (Ra) to the target user.

Further, the controller 160 may perform various controls to control the robot (R) arranged in the space 10. For this, the controller 160 may recognize the robot (R) arranged in the space 10 in various manners, thereby checking a current location of the robot (R) or controlling an operation of the robot. Further, the controller 160 may recognize the robot (R) arranged in the space 10 in various manners, thereby managing the task allocated to the robot.

As shown in FIG. 4, identification information of the robot (R) may be included in an identification mark (or an identification sign) included in the robot (R). As is mentioned above, the identification mark may be scanned by the scan unit 150 of the delivery system 100. As shown in FIGS. 4(a), 4(b) and 4(c), identification marks 401, 402, 403 of the robot (R) may include identification information of the robot. As shown, the identification marks 401, 402, 403 may be represented as a barcode 401, series information (or serial information) 402, a QR code 403, an RFID tag (not shown) or an NFC tag (not shown), etc. The barcode 401, the sequence information (or serial information) 402, the QR code 403, the RFID tag (not shown) or the NFC tag (not shown), etc. may be configured to include identification information of the robot at or to which an identification mark has been provided (or attached).

The identification information of the robot is information for discerning each robot. And even the same type of robots may have different identification information. The information which constitutes the identification marks may include various configurations as well as the aforementioned barcode, sequence information, QR code, and the RFID tag (not shown) or the NFC tag (not shown).

The controller 160 may extract identification information of the robot (R) based on an image received from the camera 20 or based on identification (or scanning) of the aforementioned identification mark by the scan unit 150, thereby specifying the robot which is to perform delivery of the object.

Further, the controller 160 may extract identification information of the robot (R) based on an image received from the camera 20 or based on identification (or scanning) of the aforementioned identification mark by the scan unit 150, thereby checking a location of the specified robot (R) in the space 10.

The estimation of the location of the robot (R) may be performed by various methods as well as the aforementioned method using the camera provided in the space 10. For instance, as shown in FIG. 5, the delivery system 100 or the controller of the robot (R) is configured to receive images about the space 10 by using the camera (not shown) included in the robot (R), and to perform Visual Localization to estimate the location of the robot from the received images. Here, the camera included in the robot may be configured to capture (or sense) images about the space 10, i.e., images around the robot. According to at least some example embodiments, the robot (R) may include one or more cameras. A camera included in the robot (R) may also be referred to, in the present specification, as a robot camera.

As shown in FIG. 5(a), the delivery system 100 or the controller of the robot (R) is configured to obtain an image by the camera included in the robot (R). And the delivery system 100 or the controller of the robot (R) may estimate a current location of the robot (R) based on the obtained image.

The delivery system 100 or the controller of the robot (R) may compare the image obtained by the robot (R) with map information stored in the storage unit 120. Then, as shown in FIG. 5(b), position information corresponding to the current location of the robot (R) (e.g., “section of A on the third floor (3, 1, 1)” may be extracted.

As is mentioned above, the map for the space 10 in accordance with at least some example embodiments may be a map preset based on Simultaneous Localization and Mapping (SLAM) by at least one robot moving in the space 10. Specifically, the map for the space 10 may be a map generated based on image information.

In other words, the map for the space 10 may be a map generated by a vision (or visual) based SLAM technology.

Thus, the delivery system 100 or the controller of the robot (R) may specify coordinate information (e.g., area of A on the third floor (3, 1, 1)) with respect to an image acquired from the robot (R), as shown in FIG. 5(b). As such, specific coordinate information may become the current location information of the robot (R).

Here, the delivery system 100 or the controller of the robot (R) may estimate a location (or a current location) of the robot (R) by comparing the image acquired from the robot (R) with the map generated by a vision (or visual)-based SLAM technology. In this case, the delivery system 100 or the controller of the robot (R) may i) specify an image most similar to the image acquired from the robot (R) by using image comparison between the image acquired from the robot (R) and images that constitute the pre-generated map, and ii) specify location information of the robot (R) by acquiring location information that is matched with the specified image.

As such, the delivery system 100 or the controller of the robot (R) may specify a location (or a current location) of the robot by using an image acquired from the robot (R) as shown in FIG. 5(a). As described above, the delivery system 100 or the controller of the robot (R) may extract location information (e.g., coordinate information) corresponding to the image acquired from the robot (R), from the map information stored in the storage unit 120 (e.g., may be also referred to as “reference map”).

The image control system 2000 shown in FIG. 3 may be configured to control at least one camera 20 arranged in the space 10. As shown, a plurality of cameras 20a, 20b, 20c, 20d, . . . may be arranged in the space 10. The plurality of cameras 20a, 20b, 20c, 20d, . . . may be arranged on different positions in the space 10.

Since the plurality of cameras 20a, 20b, 20c, 20d, . . . are arranged on different positions in the space 10, it is possible for the delivery system 100 to monitor an operation of the robot (R) or to certify a position of a target user, by using the plurality of cameras 20a, 20b, 20c, 20d, . . . .

The image control system 2000 may provide, to the delivery system 100, information required for task performance of the robot (R), through communications with the delivery system 100. As aforementioned in the configuration of the storage unit 120, a storage unit of the image control system 2000 may be configured to store various information on the camera 20. The information on the camera 20 may be variable, and may include i) identification information of each camera (20a, 20b, 20c, 20d . . . ) (e.g., serial numbers, TAG information, QR code information, etc.), ii) arrangement position information of each camera (20a, 20b, 20c, 20d . . . ) (e.g., information on a specific position in the space where each camera (20a, 20b, 20c, 20d . . . ) is arranged), iii) information on an angle of view of each camera (20a, 20b, 20c, 20d . . . ) (e.g., information on a specific view in the space captured by each camera (20a, 20b, 20c, 20d . . . )), iv) position information on a region (or a space or a specific space) corresponding to an angle of view of each camera (20a, 20b, 20c, 20d . . . ), v) status information of each camera (20a, 20b, 20c, 20d . . . ) (e.g., a power condition, presence of a malfunction, a battery condition, etc.), vi) image information received from each camera (20a, 20b, 20c, 20d . . . ), etc.

The information on the camera 20 may exist in a matching manner on the basis of each camera (20a, 20b, 20c, 20d . . . ).

For instance, at least one of identification information of the specific camera 20a, position information, view angle information, status information and image information may exist in the storage unit of the image control system 2000 as matching information.

In the following descriptions, for convenience, it will be explained that the aforementioned information on the camera is stored in the storage unit 120, without discernment of a type of the storage unit (or storage place). According to at least some example embodiments, the information on the camera may be stored in any know type of storage device (i.e., memory).

According to the above descriptions, According to at least some example embodiments, the image control system 2000 and the delivery system 100 are configured as separate configurations. However, at least some example embodiments are not limited to this. For example, the image control system 2000 and the delivery system 100 may be configured as a single integrated system. In this case, the image control system 2000 can be also referred to as a “camera unit”.

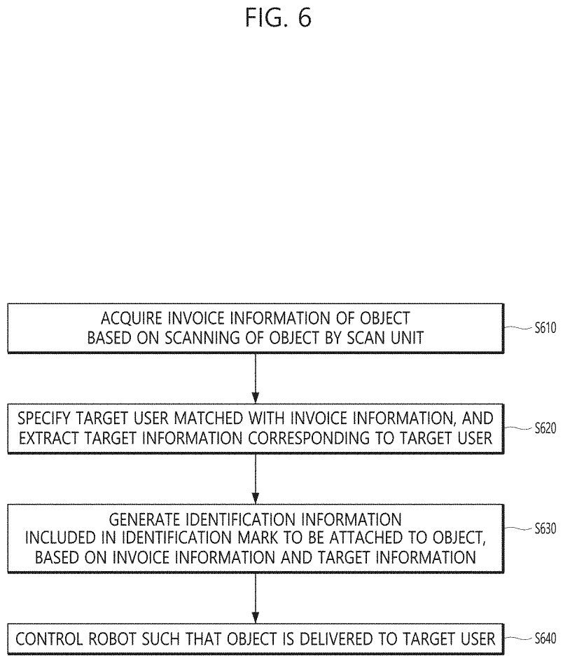

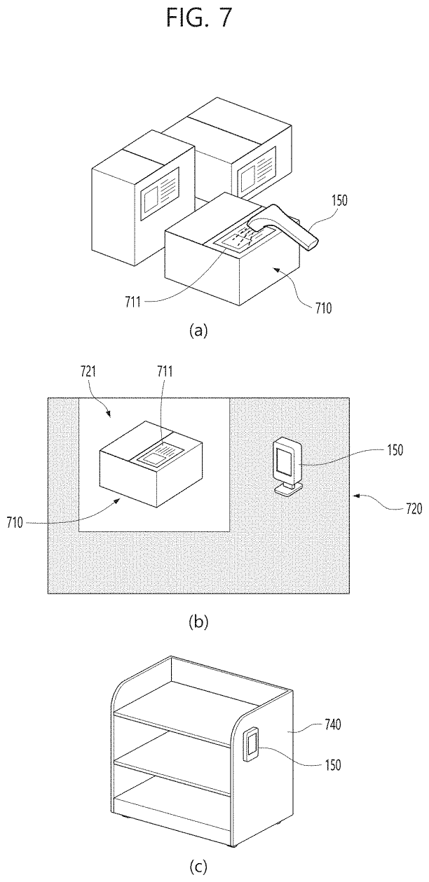

Hereinafter, a delivery method using a robot according to at least some example embodiments will be explained in more detail with reference to the aforementioned configuration. FIG. 6 is a flowchart for explaining an object delivery method using a robot according to at least some example embodiments, and FIGS. 7, 8, 9A, 9B, 10A, 10B, 10C, 10D, FIG. 11, FIG. 12A and FIG. 12B are conceptual views for explaining an object delivery method using a robot according to at least some example embodiments.

Firstly, According to at least some example embodiments, a process of acquiring invoice information of the object may be performed based on scanning of the object by the scan unit (S610).

As shown in FIG. 2, the scan unit 150 may be included in the reception region 502 (refer to FIG. 2) where the object is collected. The scan unit 150 may be configured to acquire invoice information included in the object 503.

In this specification, for convenience of explanations, “invoice information” is used for unification of terms. However, the “invoice information” can be replaced by another term.

The “invoice information” acquired by the scan unit may be expressed as “information about an object”.

The invoice information includes information on a target user (recipient) to which the object is to be delivered, and may further include at least one of postal matter information, an invoice number, delivery company information, sender information, and description information about the object (e.g., a type of the object (shoes, clothes, etc.).

According to at least some example embodiments, in case of collecting the objects 503, the collected objects may be received at the reception region 502. The reception of the objects may include a task to acquire invoice information included in the objects, and to specify a target user of the objects.

The scan unit 150 may be formed to have various forms and may be arranged at various places, thereby performing scanning with respect to the objects.

For instance, as shown in FIG. 7(a), the scan unit 150 may be formed to be moveable by an operator (e.g., a person who performs reception with respect to the objects, or the robot (or task robot)). For instance, as shown in FIG. 7(a), the scan unit 150 may be formed as a handy type. In this case, the operator may approach the scan unit 150 to an object 710 with holding the scan unit 150. Thus, the scan unit 150 may acquire invoice information through scanning of an invoice 711 included in the object 710.

As another example, as shown in FIG. 7(b), the scan unit 150 may be included in a worktable 720 (e.g., a desk, a table, etc.) of the reception region 502. In this case, the scan unit 150 may be installed by being fixed to the worktable 720. The operator may approach the object 710 to the scan unit 150, and the scan unit 150 may perform scanning of the object 710 located near the scan unit 150.

The worktable 720 may include a guide region 721. Here, the guide region 721 may include guide information about a two-dimensional space or a three-dimensional space.

The guide region 721 may have a size equal to or smaller than that of the accommodation box (Ra) (refer to FIG. 3) included in the robot (R). The operator may locate objects at the guide region 721, and then may select an object having a smaller size than the guide region as the object to be delivered by the robot (R).

Although not shown, the scan unit 150 may be arranged on at least one part of the guide region 721. Thus, According to at least some example embodiments, invoice information included in the object may be scanned by the scan unit 150, as the operator merely locates objects at the guide region 721 in order to select an object which can be accommodated in the accommodation box (Ra).

As another example, as shown in FIG. 7(c), the scan unit 150 may be arranged on at least a region of a storage box 740. In this case, invoice information included in the object may be scanned by the scan unit 150, through the operator's single operation to move the object to the storage box 740 in order to store the object in the storage box 740.

In this case, identification information of the scan unit 150 included in the storage box 740 and identification information of the storage box 740 may exist in the storage unit 120, and such information may exist in a matching manner. Thus, in case of scanning the object by the scan unit 150 included in the storage box 740, the controller 160 may acquire all of the identification information of the storage box 740 where the object has been stored, and invoice information of the object.

For example, in case of receiving the invoice information from the scan unit 150, the controller 160 may extract identification information of the scan unit 150 which has scanned the invoice information, from the received information. The controller 160 may extract, from the storage unit 120, identification information of the storage box 740 matched with the identification information of the scan unit 150. And the controller 160 may specify the storage box 740 corresponding to the extracted identification information, as a storage box where the object has been stored.

According to at least some example embodiments, after the invoice information is acquired based on scanning of the object, a process of specifying a target user matched with the invoice information may be performed, and target information corresponding to the specified target user may be extracted (S620).

As is mentioned above, the user DB where user-related information has been stored may exist in the storage unit 120.

The user-related information may include at least one of a user name, a date of one's birth, an address, a phone number, an employee identification number, an ID, a facial image, bio information (fingerprint information, iris information, etc.), user's location information (e.g., a user's living place in the space 10 (e. g, a working place (or a working region), a residential place, etc.)), identification information of an electronic device of a user, a user's email address, and information related to a user's plan (schedule).

The controller 160 may compare the invoice information with the user DB, thereby specifying a target user corresponding to the invoice information. In the case that the target user is specified, the controller 160 may extract target information of the target user from the aforementioned user DB.

The target information may include location information of the target user within a space where the robot (R) which delivers the object can access. Further, the target information may further include at least one of a name of the target user, a phone number, identification information (phone number) of an electronic device of the target user, an e-mail address, bio information, plan (schedule) information, a facial image, an employee identification number and an identification.

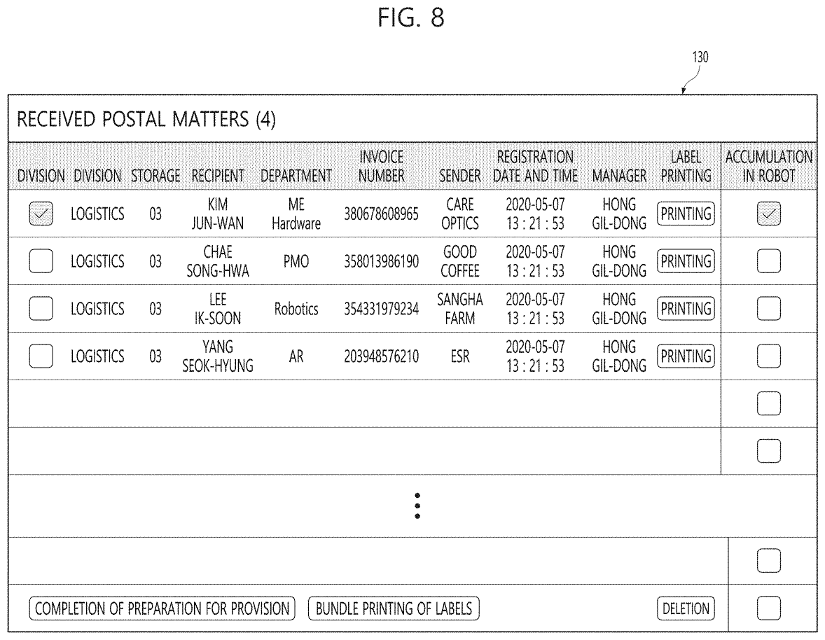

For instance, as shown in FIG. 8, the controller 160 may specify a target user (a recipient: Kim Jun-wan) corresponding to invoice information (invoice number: 380678608965), from the user DB, and may extract target information (e.g., department: ME Hardware) of the target user.

As shown in FIG. 8, the controller 160 may store, in a matching manner, at least one of invoice information (invoice number: 380678608965, a sender: care optics), the target information of the target user (a recipient: Kim Jun-wan, department: ME Hardware), the identification information of the storage box where the object has been stored (e.g., 03) and identification information of the robot (R) allocated with a delivery task with respect to the corresponding object.

As shown, the user DB related to delivery of the object can exist separately. Once the invoice information is acquired from the object and the target user corresponding to the acquired invoice information is specified, the controller 160 may update information related to delivery of the object to the target information of the target user. Here, the update may mean storing information related to delivery of the object in a matching manner, on the basis of the target user.

The update may be sequentially performed according to a delivery state of the object.

Firstly, once a target user is specified from invoice information of a specific object, the controller 160 may update the target information included in the user DB.

The controller 160 may update the target information such that the target information of the target user includes the invoice information.

Once the specific object is stored in the storage box and the identification information of the storage box is received, the controller 160 may update the user DB (more specifically, the target information included in the user DB) such that the target information of the target user includes the identification information of the storage box.

Here, the identification information of the storage box may be received through scanning of an identification mark included in the storage box by the aforementioned scan unit 150, or through the operator's input to the input unit 140.

In a case that the robot (R) which delivers the specific object is specified, the controller 160 may update identification information of the specified robot (R) to the target information of the target user.

For example, the controller 160 may update the user DB (more specifically, the target information included in the user DB) such that the target information of the target user includes the identification information of the specified robot (R).

Thus, as shown in FIG. 8, the user DB may store therein the target information of the target user, in a matching manner with i) information about an object (e.g., invoice information), ii) identification information of a storage box where the corresponding object has been stored, and iii) identification information of the robot (R) allocated with a delivery task with respect to the corresponding object.

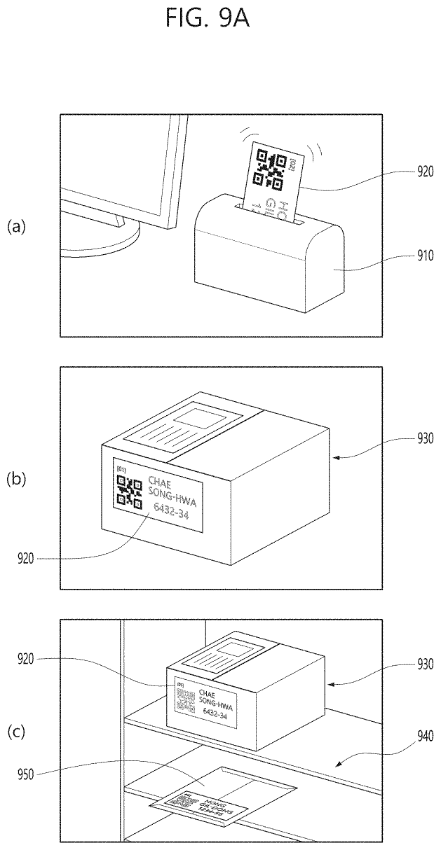

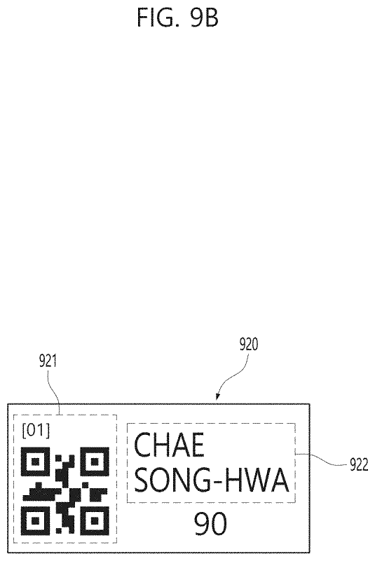

According to at least some example embodiments, a process of generating identification information included in an identification mark to be attached to an object, based on invoice information and target information, may be performed (S630). As shown in FIGS. 9A and 9B, identification information may include at least one of invoice information and target information. Here, the identification information may include at least a part of invoice information.

The controller 160 may generate identification information by using at least one of invoice information, target information and storage box information.

As shown in FIG. 9A(a), the system 100 according to at least some example embodiments may output an identification mark 920 including the identification information. The identification mark 920 may be formed as a sticker, and may be attached to an object 930 as shown in FIG. 9A(b). In a case that an operator's output request with respect to the identification mark 920 is received, the controller 160 may control an output unit 910 to output the identification mark 920 including the identification information. As shown in FIG. 8, function icons (e.g., “print” icons) to output identification marks may be output to the operator's display unit 130. A user's request may be received based on selection of the function icon by the operator. Thus, according to at least some example embodiments, the controller 160 may generate identification information (e.g., based on at least one of invoice information, target information and storage box information) and generate an identification mark including the identification information.

As shown, the controller 160 may output an identification mark of a target user (e.g., name: Chae Song-hwa) corresponding to a selected icon 131.

The identification information may include code information which can be identified by a scan unit included in the robot (R) which delivers the object. For example, the robot (R) may include a scan unit which may be, for example, a scanner. The scan unit (or scanner) of the robot (R) may also be referred to, in the present specification, as the robot scan unit (or robot scanner). For example, the robot scanner may be or include, for example, a barcode scanner, a QR code scanner, an optical character recognition (OCR) scanner, an RFID reader and/or NFC reader.

Here, the code information may be configured as at least one of a barcode, series information (or serial information), a QR code, an RFID tag and an NFC tag.

The code information included in the identification information may include at least one of invoice information about an object, name information of a target user for an object, and location information of the target user. Further, the identification information may include a serial number of an object. Here, the serial number of an object may be a number provided by the controller 160 in order to intuitively identify an object.

As shown in FIG. 9B, an identification mark 920 may include at least one of code information 921 and target information of a target user (e.g., name: Chae Song-hwa). And the identification mark 920 may further include a serial number (e.g., 90) of the object.

Once the identification mark 920 is output by the output unit 910 as shown in FIG. 9A(a), the identification mark 920 may be attached to the object 930 by the operator as shown in FIG. 9A(b). And the object 930 to which the identification mark 920 has been attached may be stored in a storage box 940, as shown in FIG. 9A(c).

The object 930 may be stored in the storage box 940 until a delivery event with respect to the object starts. As is mentioned above, the storage box where the object 930 has been stored may be a storage box matched with the target information of the target user.

As is mentioned above, if there exists an object to be delivered to a target user, the controller 160 may transmit notification information indicating existence of a delivery event with respect to the object, to a post office box (e.g., an e-mail box, a messenger box, etc.) corresponding to an electronic device of the target user or the target user's account.

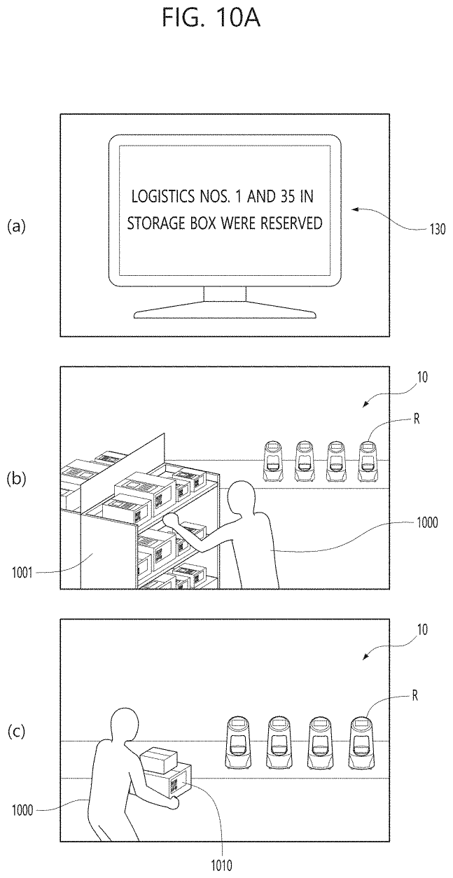

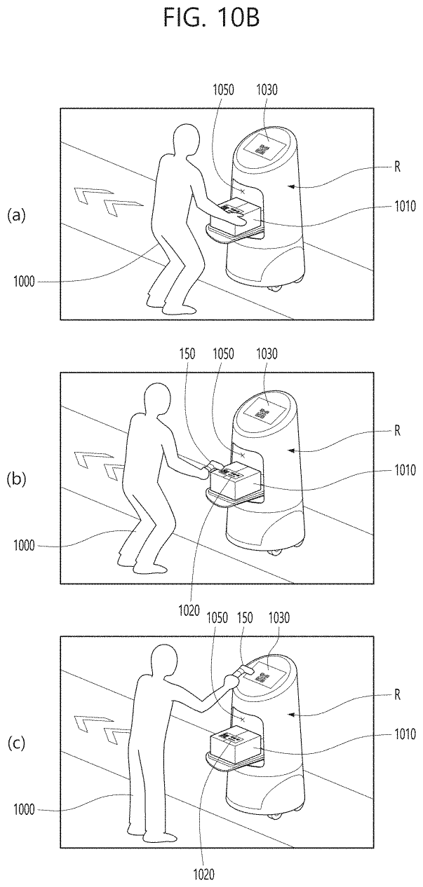

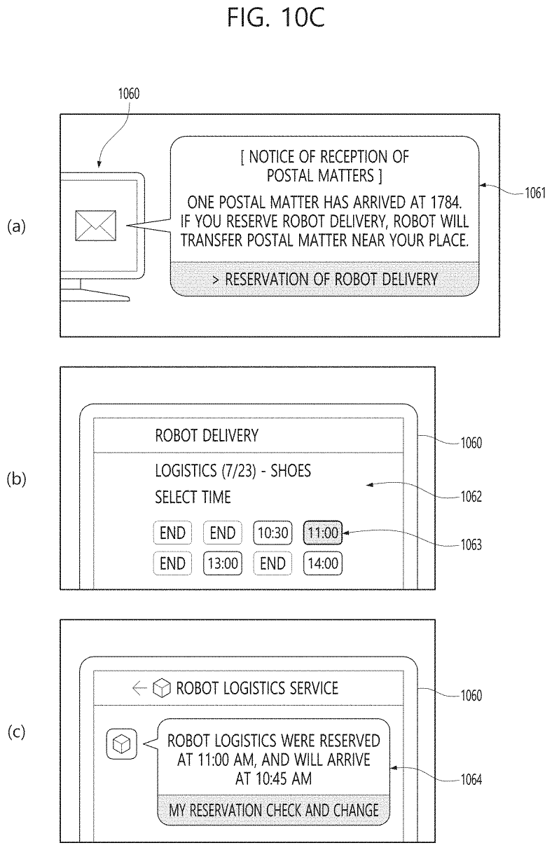

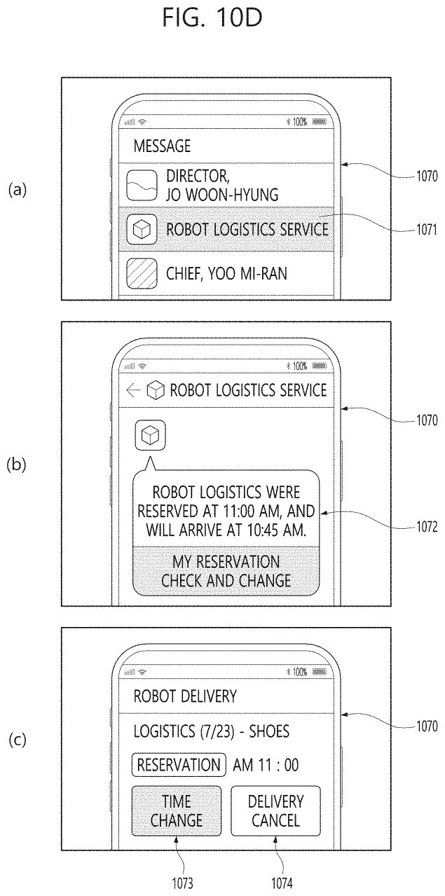

As shown in FIG. 10C(a) or FIG. 10D(a), notification information 1064 indicating existence of an object to be delivered may be output to an electronic device of a target user (or an electronic device to which a target user's account has been logged-in) (hereinafter, will be referred to as ‘electronic device of a target user’). Accordingly, the target user may recognize the existence of the object.

In a case that invoice information of an object, storage box information, etc. are updated to the user DB, the controller 160 may transmit notification information indicating existence of a delivery event with respect to the object, to the electronic device of the target user registered to the user DB, based on the update.

The controller 160 may variously control a transmission time of the notification information indicating existence of a delivery event.

For instance, the controller 160 may determine a transmission time when the notification information is transmitted to the target user, based on history information of the target user. The history information may include information on a delivery time (or a delivery reservation time) previously requested by the target user. The controller 160 may determine a transmission time of the notification information based on a delivery time frequently requested by the target user.

Further, the history information may include information on a delivery reservation time previously requested by the target user (e.g., 3:00 PM). The controller 160 may determine a transmission time of the notification information based on a delivery reservation time frequently requested by the target user.

As another example, in a case that a plurality of objects have been received, the controller 160 may categorize a plurality of target users corresponding to the plurality of objects into a plurality of groups, and may transmit the notification information to each group at a different time. This is in order to reduce congestion of a delivery task.

Next, According to at least some example embodiments, a process of controlling the robot such that the object is delivered to the target user may be performed (S640).

According to at least some example embodiments, a series of processes for delivering the object to the target user may be performed based on a delivery request with respect to the object.

Here, the delivery request may be implemented based on reception of delivery request information from the target user, the operator or the controller 160.

The delivery request from the target user may be received from an electronic device of the target user or an account of the target user (e.g., an e-mail account, etc.).

As shown in FIG. 10C(a), the received delivery request may include information about a delivery request time. Here, the delivery request time may be represented as “reservation time” or “reservation time related to a delivery event”.

Here, the delivery request time may mean a time that the target user wishes to receive the object. As shown in FIG. 10C(b), the delivery request time (e.g., 11:00) may be selected or inputted from an electronic device 1060 of the target user.

Based on reception of a delivery request, the controller 160 may allocate a task related to object delivery to the robot (R) such that the object is delivered to the target user by the robot (R). Further, the controller 160 may control the robot (R) such that the object is delivered at a delivery request time (or a reservation time) included in the received delivery request.

For example, based on reception of delivery request information including a reservation time related to a delivery event with respect to the target user from the electronic device of the target user, the controller 160 may control the robot (R) such that the object is delivered to the target user at the reservation time. The controller 160 may control a task execution time of the robot (R) based on the delivery request time.

In the case that the delivery request is received, the controller 160 may extract information of the object corresponding to the delivery request. Here, as shown in FIG. 10A, the object information may include at least one of identification information of a storage box where the object corresponding to the delivery request has been stored (or information on a storage place, e.g., storage box 1) and a serial number of the object (e.g., No. 35). As shown in FIG. 10A(a), the object information may be output to the display unit 130. Based on reception of the delivery request, the controller 160 may output the object information to the display unit 130. Thus, the operator may certify the object information outputted to the display unit 130, and may easily identify information of a storage box 1001 where the delivery-requested object has been stored and an object 1010 to be delivered as shown in FIGS. 10A(b) and (c).

The delivery system 100 according to at least some example embodiments may determine information about a time when object delivery is started by the robot (R), based on distance information between a specific place (e.g., a delivery work place) controlled by the delivery system 100, aforementioned with reference to FIG. 2 and the target user.

The controller 160 may calculate a travel time taken for the robot (R) to move from the specific place to a place where the target user is located, based on distance information between the specific place and the place where the target user is located.

Here, the place where the target used is located may be extracted from the user DB. The place where the target user is located, a delivery place to which the object is delivered may be not only extracted from the user DB as is mentioned above, but also may be a place requested by the target user. And the controller 160 may output information on the object of which delivery request has been received, to the display unit 130, before a preset time including the calculated travel time. For example, the controller 160 may control a task which accumulates the object in the robot (R), to be performed at a proper time, in order to prevent the robot (R) from delivering the object too earlier or too later than a reservation time.

For instance, in a case that the calculated travel time is 10 minutes, the preset time may be a time including the calculated travel time (e.g., 10 minutes) and a reference or, alternatively, minimum task time taken for the operator to accumulate the object in the robot (R) (e.g., 10 minutes). Thus, in this case, information on the object of which delivery request has been received may be output to the display unit 130, at a time prior to the reservation time by 20 minutes (e.g., at a time that precedes the reservation time by a desired amount of time which may be, for example, 20 minutes). The operator may check the information on the object output to the display unit 130, and may accumulate the object in the robot (R).

As shown in FIG. 10B(a), an object 1010 requested to be delivered may be accommodated in an accommodation box 1050 of the specific robot (R) by an operator 1000. The operator may accumulate (e.g., put or place) the object 1010 in the accommodation box 1050 of the specific robot (R), such that the delivery-requested object 1010 is delivered to the target user.

Here, as shown in FIG. 10B(b), the controller 160 may scan an identification mark 1020 attached to the delivery-requested object 1010 and accumulated in the specific robot (R), by the scan unit 150. Here, the identification mark 1020 may be the identification mark 920 output by the output unit 910 aforementioned in FIG. 9A. Further, as shown in FIG. 10B(c), the scan unit 150 may scan identification information 1030 of the specific robot (R). Based on the scanning of the identification mark 1020 attached to the delivery-requested object 1010 and the identification information 1030 of the specific robot (R) by the scan unit 150, the controller 160 may extract target information of a target user who will receive the delivery-requested object 1010, and identification information of the specific robot (R) which will perform a delivery task with respect to the delivery-requested object 1010.

Based on the sequential scanning of the identification mark 1020 attached to the delivery-requested object 1010 and the identification information 1030 of the specific robot (R) by the scan unit 150 (regardless of the order), the controller 160 may determine that the robot (R) which will deliver the delivery-requested object 1010 has been specified. And the controller 160 may, for example, link or, alternatively, add identification information of the specified robot (R) to target information of the target user.

For example, the controller 160 may update the user DB (more specifically, target information included in the user DB), such that target information of the target user includes identification information of the specified robot (R). In this case, the user DB discussed above with reference to FIG. 8 may further include identification information of the robot (R). Further, in a case that the robot which will deliver the object is specified, the controller 160 may generate an event, e.g., “the corresponding object has been accumulated in the robot (R)”.

The event, e.g., “that the object has been accumulated in the robot (R),” may be represented as a delivery start event.

In a case that the identification mark 1020 attached to the delivery-requested object 1010 is scanned by the robot scan unit included in the robot (R), the controller 160 may generate a delivery start event.

Such information indicating the occurrence of the delivery start event may be updated to the user DB including target information of the target user for the delivery-requested object.

For example, information on the delivery start event may be updated to target information of the target user included in the user DB.

Based on the update of the information on the delivery start event to the user DB, the controller 160 may transmit, to an electronic device of the target user, notification information indicating that delivery of the delivery-requested object has started.

For instance, as shown in FIGS. 10C(c) and 10D(b), notification information 1064, 1072 indicating that delivery of the delivery-requested object has started may be transmitted to electronic devices 1060, 1070 of the target user.

As shown, the notification information 1064, 1072 may further include information on an expected time of arrival about a time when the robot (R) is to arrive at a place where the target user is located.

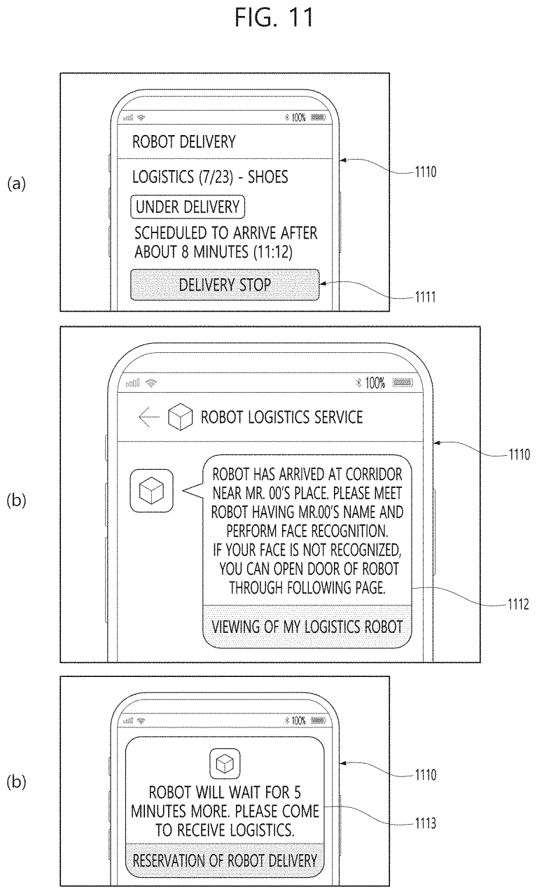

According to at least some example embodiments, various requests related to delivery, such as a delivery reservation time change request 1073, a delivery cancel request 1074 each shown in FIG. 10D(c), and a delivery stop request 1111 shown in FIG. 11, may be received from the electronic device of the target user. In a case that the aforementioned delivery-related request is received from the electronic device of the target user, the controller 160 may perform control corresponding to the received delivery-related request to the robot (R). For instance, in a case that a delivery time change request, a delivery stop request or a delivery cancel request is requested from the electronic device of the target user after the robot (R) has started for delivery, the controller 160 may cancel the task allocated to the robot (R) and may control the robot (R) to return to a specific place.

As shown in FIG. 11, a delivery state of the robot (R) (e.g., under delivery) and information on an expected time of arrival may be updated to an electronic device 1110 of the target user in real time or at preset time intervals. For example, the controller 160 may transmit a delivery state of the robot (R) (e.g., under delivery) and information on an expected time of arrival, to the electronic device of the target user in real time or at preset time intervals.

As shown in FIG. 11(b), in a case that the robot (R) is located at a place where the target user is located (or a delivery place to which the object is to be delivered), the controller 160 may transmit notification information indicating that the robot (R) has arrived at the corresponding place, to the electronic device of the target user.

Further, in a case that the robot (R) has not met the target user till an object delivery reservation time, the controller 160 may transmit information on an additional waiting time to the electronic device of the target user, as shown in FIG. 11(c).

Here, the information on an additional waiting time may be determined based on a relative distance between a current location of the target user and the delivery place.

The controller 160 may certify a current location of the target user in the space 10 by recognizing a face from an image received from the camera arranged in the space 10, by recognizing an identification mark of a target user 1000, by recognizing an electronic device of the target user 1000, etc.

In a case that a distance from the current location of the target user to the delivery place or an expected time of movement is within a preset range or a preset time, the controller 160 may set an additional waiting time. Here, the additional waiting time means a time duration taken for the robot (R) to wait for the target user at the delivery place in order to deliver the object to the target user, by exceeding a delivery reservation time.

In a case that the additional waiting time is set, the controller 160 may transmit, to the robot (R), a control command to additionally wait for the target user at the delivery place for the additional waiting time.

According to at least some example embodiments, the controller 160 may allocate a task to the robot (R) for object delivery. As shown in FIG. 10B(c), the controller 160 may allocate an object delivery task to the robot (R) having its identification information scanned by the scan unit 150.

The controller 160 may transmit a control command to perform the object delivery task, to the corresponding robot (R). Such a control command may include place information (or location information) on a delivery place to which an object is to be delivered.

“Allocation of a task to the robot (R))” is provision of a task to the robot (R), and more specifically, may mean input or transmission of a control command to the robot (R) such that the robot (R) performs an allocated task. In a case that a task is allocated to the robot (R), the robot (R) may include an algorithm to perform the allocated task. For example, the robot (R) may be programmed to perform the allocated task. The controller of the robot (R) may perform an operation to execute the allocated task (e.g., object delivery) by a preset algorithm and program. The operation of the robot (R) to execute the allocated task may be so various. For instance, the operation of the robot (R) may be understood to include all of operations related to navigation of the robot, a task of the robot, a power state of the robot, etc.

The control command inputted or transmitted to the robot (R) for allocation of a task to the robot (R) may include at least one command for driving the robot (R) such that the robot (R) performs an allocated task. The task allocation to the robot (R) may be performed through various paths. For instance, a task may be allocated by the delivery system 100 according to at least some example embodiments. The controller 160 may be configured to allocate a task to the robot (R). For task allocation to the robot (R), the controller 160 may transmit a task-related control command to the robot (R) through the communication unit 110. Such a control command may include a control to perform a task by the robot (R).

Here, the controller 160 may perform a control related to navigation of the robot (R) such that the robot (R) moves to a specific place matched with a task. The controller 160 may control the robot (R) to move to the specific place matched with the task, by transmitting a control command corresponding to the task to the robot (R). The control command corresponding to the task allocated to the robot (R) may include task-related information. As is mentioned above, the task-related information may include information related to at least one of a task type, an operation according to a task, information of a target user to which a task is to be performed, a task execution place (or a specific place matched with a task (for instance, a delivery place)) and a task execution reservation time (e.g., a delivery reservation time).

When the robot (R) receives the control command corresponding to the task from the controller 160, the robot (R) may move to a specific place matched with the task in order to perform the allocated task, based on the task-related information. The controller of the robot (R) may move to a task execution place based on task-related information received from the delivery system 100.

Task allocation to the robot (R) may be performed based on input of task information to the robot (R). In this case, the robot (R) may receive task-related information through the robot scan unit included in the robot (R). A subject which inputs task-related information through the scan unit of the robot (R) may be a person or a robot different from the robot (R) to which a task is allocated.

Like this, task allocation to the robot (R) may be performed in various manners. And the robot (R) may perform an operation for task execution based on the task allocation.

As is mentioned above, the task allocated to the robot (R) may be a task to provide a service for delivering an object to a target user.

Once the robot (R) arrives at a delivery place for task execution, the controller of the robot (R) may control a navigation unit of the robot (R) to stop driving at the delivery place. The robot (R) may perform an operation to wait for a target user at the delivery place. Here, an operation state of the robot (R) may be a power-off state of an output unit such as the display unit, or an operation state of a sleep mode operated as a low or, alternatively, minimum power usage mode, a standby mode or a power saving mode.

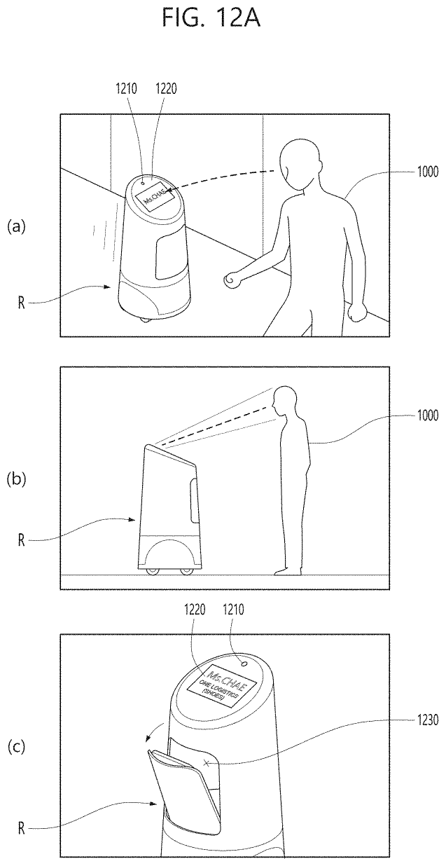

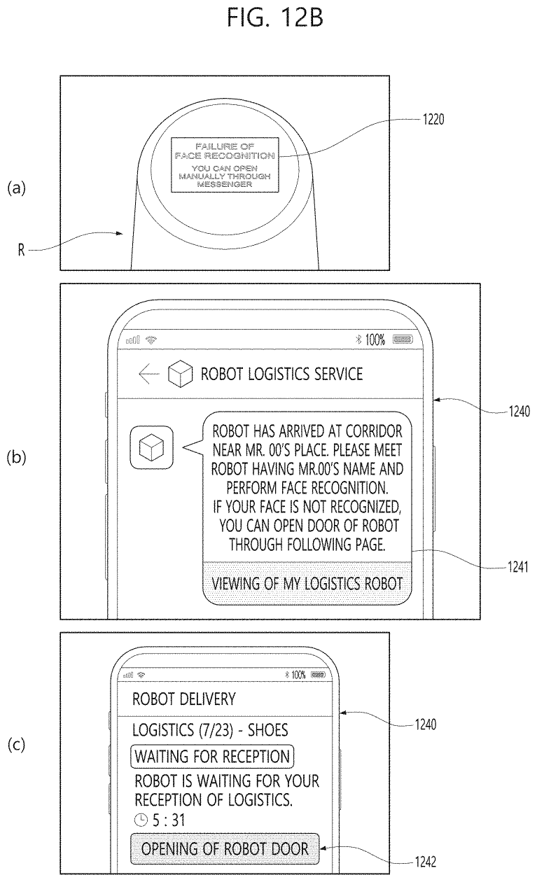

In such an operation state, the controller of the robot (R) may monitor a surrounding situation of the robot (R) by using the camera included in the robot (R), at preset time intervals or in real time. The robot (R) may collect images about the surrounding situation by using the camera, and may identify a target user 1000 from the collected images, as shown in FIG. 12A(a).

In this case, the controller of the robot (R) may output identification information (e.g., a name) of the target user 1000 through a display unit 1220 or a speaker. Thus, the target user 1000 may easily recognize the robot (R) which will perform a service for himself or herself.

In a case that user authentication to authenticate the target user 1000 is completed through a user authentication process, the controller of the robot (R) may perform a task with respect to the target user 1000. The controller of the robot (R) may perform authentication with respect to the target user 1000 by using at least one of various user authentication methods such as face recognition (refer to FIG. 12A(b)), fingerprint recognition, iris recognition, voice recognition, password input, and identification mark scanning. The controller of the robot (R) may perform user authentication by using various sensors (e.g., camera 1210) included in the robot (R).

For example, the controller of the robot (R) may prevent the allocated task from being executed for a third party unrelated to the task, through an authentication process to authenticate a user who has accessed the robot (R) is a substantial user corresponding to the target user matched with the allocated task.

In a case that user authentication is completed, the controller of the robot (R) may provide a service corresponding to the task to the target user 1000. For instance, if the allocated task is object delivery, the controller of the robot (R) may control a storage box (or an accommodation box) 1230 of the robot (R) where an object has been stored, to be open such that the target user 1000 takes the object out. Through this process, the controller of the robot (R) may complete performance of the task for the target user 1000.

In a case that the robot's user authentication (e.g., face recognition) aforementioned in FIG. 12A fails (refer to FIG. 12B(a)), the delivery system 100 may provide an additional authentication method. For instance, as shown in FIG. 12B(b) and 12B(c), the delivery system 100 may provide a user environment to perform user authentication at an electronic device 1240 of the target user. As shown in FIG. 12B(c), a function icon 1242 corresponding to a function to open the accommodation box of the robot (R) may be output to the electronic device 1240 of the target user. In a case that a selection signal for the function icon 1242 is received from the electronic device 1240 of the target user, the controller 160 may transmit a control command to the robot (R) such that the accommodation box of the robot (R) is open. Through this, a user may take the object out from the robot (R).

As is mentioned above, in the delivery method and system using a robot, information on a target user corresponding to a recipient of an item (or an object) to be delivered may be acquired based on invoice information attached to the object. Further, According to at least some example embodiments, an identification mark which can be scanned by a robot may be generated by using the acquired target user information and the invoice information, and the object may be delivered to the target user by a robot which has scanned the identification mark. Accordingly, in the delivery method and system using a robot, a manager who manages object delivery allows the robot to deliver the object to the target user, even if he or she does not directly input information on a destination of the object. This may enhance efficiency of a task.

Further, in the delivery method and system using a robot, information on a storage place where collected objects have been stored is input to the user DB. Accordingly, in a case that the target user requests for object delivery, the information on the storage place may be provided from the user DB. This may reduce difficulty of the manager who manages object delivery in directly searching for the storage place where the object has been stored, in order to deliver the object to the target user.

Operations according to at least some example embodiments may be executed by one or more processors in a computer, for example, processors executing instructions in program code stored in a computer-readable medium.

For example, a program including computer-executable instructions for causing a processor to perform operations in accordance with example embodiments may be stored in a computer-readable medium.

The computer-readable medium includes all types of recording devices for storing data which can be read by a computer system. Examples of the computer-readable medium include a Hard Disk Drive (HDD), a Solid State Disk (SSD), a Silicon Disk Drive (SDD), ROM, RAM, CD-ROM, a magnetic tape, a floppy disk, an optical data storage device, etc.

Further, the computer-readable medium includes a storage unit which may be a server or a cloud storage unit to which an electronic device can access through communications. In this case, the computer may download, from the server or the cloud storage unit, through wired or wireless communications, a program including program instructions for causing a processor executing the program instructions to implement example embodiments.

Further, According to at least some example embodiments, the aforementioned computer is an electronic device where a processor, i.e., a Central Processing Unit (CPU) is mounted, and there is no limitation in a type of the computer.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A delivery method comprising:
acquiring invoice information of an object based on scanning of the object by a scanner;
specifying a target user matched with the invoice information by using a user database (DB);
extracting target information corresponding to the target user from the user DB;
generating identification information based on the invoice information and the target information;
generating an identification mark, including the identification information, to be attached to the object; and
controlling a robot which has scanned the identification mark to deliver the object to the target user.

2. The method of claim 1, wherein the extracting of the target information includes extracting target information including location information of the target user from the user DB, the location information identifying a location the robot can access.

3. The method of claim 2,
wherein the identification information includes code information which can be identified by a robot scanner, the robot scanner being a scanner included in the robot, and
wherein the code information includes at least one of the invoice information, name information of the target user, and the location information.

4. The method of claim 1, further comprising:
updating the user DB such that at least one of the invoice information and information on a storage place where the object is stored is included in the target information.

5. The method of claim 4, further comprising:
transmitting notification information indicating existence of a delivery event with respect to the object to an electronic device of the target user registered to the user DB, based on the updating of the user DB.

6. The method of claim 5, further comprising:
receiving delivery request information including a reservation time related to the delivery event from the electronic device of the target user,
wherein the controlling of the robot includes controlling the robot to deliver the object to the target user at the reservation time.

7. The method of claim 6, further comprising:
in response to the identification mark attached to the object being scanned by a robot scanner, generating a delivery start event related to the object for the target user, the robot scanner being a scanner included in the robot, and
updating information on the delivery start event to the user DB.

8. The method of claim 7, further comprising:
transmitting, to the electronic device of the target user, notification information indicating that delivery of the object has started, based on the updating of the information on the delivery start event to the user DB.

9. The method of claim 6, further comprising:
extracting information on a storage place where the object has been stored, and outputting the information on the storage place to a display, based on reception of the delivery request information.

10. The method of claim 9, wherein the information on the storage place is output to the display, at a time that precedes the reservation time by a first amount of time.

11. A delivery system comprising:
memory configured to store a user database (DB);
a scanner configured to scan an object; and
controller circuitry configured to acquire invoice information of the object based on scanning of the object by the scanner, and extract target information corresponding to a target user matched with the invoice information,
wherein the controller circuitry is further configured to,
generate identification information based on the invoice information and the target information, and
generate an identification mark including the identification information, to be attached to the object, and
wherein the controller circuitry is further configured to control a robot which has scanned the identification mark to deliver the object.
